(19) United States
(12) Patent Application Publication
(10) Pub. No.: US 2015/0210284 A1
(43) Pub. Date: Jul. 30, 2015

(54) DRIVING ENVIRONMENT ESTIMATION APPARATUS AND METHOD THEREOF

(71) Applicant: TOYOTA JIDOSHA KABUSHIKI KAISHA, Toyota-shi, Aichi-ken (JP)

(72) Inventors: Michihiro Miyashita, Susono-shi (JP); Kouhei Tochigi, Susono-shi (JP)

(73) Assignee: TOYOTA JIDOSHA KABUSHIKI KAISHA, Toyota-shi, Aichi-ken (JP)

(21) Appl. No.: 14/423,187

(22) PCT Filed: Aug. 12, 2013
(86) PCT No.: PCT/JP2013/004839

§ 371 Date: Feb. 23, 2015

(30) Foreign Application Priority Data
Sep. 13, 2012 (JP) 2012-201496

(51) Int. Cl. B60W 30/18

(52) U.S. Cl. CPC B60W 30/18009; B60W 2550/00; B60W 2550/20; B60W 2560/00

(57) ABSTRACT

A driving environment estimation apparatus for identifying either an urban or suburban area including a vehicle stop degree data acquirer to obtain data representing a degree of tendency of a vehicle stop state; and an urban area/suburban area identifier to compare the obtained vehicle stop degree data with a threshold value to identify whether a vehicle driving area is an urban or suburban area. The urban area/suburban area identifier provides a predetermined high threshold value and a low threshold value lower than the high threshold value. The urban area/suburban area identifier identifies as the urban area when the vehicle stop degree data increases from a lower value than the high threshold value to be higher than the high threshold value, and identifies as the suburban area when the vehicle stop degree data decreases from a higher value than the low threshold value to be lower than the low threshold value.

### TECHNICAL FIELD

The present invention relates to a technique of driving environment estimation that identifies whether a driving area of the vehicle is an urban area or a suburban area and a technique of controlling the vehicle.

### BACKGROUND ART

As a recent trend, the vehicle employs drive control according to the driving environment, in order to satisfy a requirement for improvement of fuel consumption. The driving environment may be distinction between an urban area and a suburban area. Various driving environment estimation apparatuses have been proposed to identify whether the driving environment is an urban area or a suburban area. For example, Patent Literature 1 describes a technique of estimating the degree of urbanization, based on a running time rate. The running time rate denotes a rate of running time to entire time including vehicle running time and vehicle stop time. In other words, this technique estimates the degree of urbanization, based on a vehicle stop time rate.

### CITATION LIST

### Patent Literature

PTL1: JP H07-105474A

### SUMMARY

### Technical Problem

The technique described in Patent Literature 1, however, has a problem of temporary misidentification of the driving environment in the case of a temporary decrease of the vehicle stop time rate in an urban area or in the case of a temporary increase of the vehicle stop time rate in a suburban area. Another problem is poor response in such identification. Other needs include, for example, simplification of the configuration, downsizing, cost reduction, resource saving and improvement of usability.

In order to solve at least part of the problems described above, an object of the invention is to allow for identification either as an urban area or as a suburban area with high accuracy.

### Solution to Problem

In order to solve at least part of the problems described above, the invention may be implemented by the following aspects.

(1) According to one aspect of the invention, there is provided a driving environment estimation apparatus. The driving environment estimation apparatus may comprise: a vehicle stop degree data acquirer configured to obtain vehicle stop degree data representing a degree of tendency of a vehicle stop state; and an urban area/suburban area identifier configured to compare the obtained vehicle stop degree data with a threshold value and thereby identify whether a driving area of the vehicle is an urban area or a suburban area. The urban area/suburban area identifier may provide a predetermined high threshold value and a low threshold value that is lower than the high threshold value, as the threshold value. The urban area/suburban area identifier may identify as the urban area when the vehicle stop degree data increases from a lower value than the high threshold value to be higher than the high threshold value, and may identify as the suburban area when the vehicle stop degree data decreases from a higher value than the low threshold value to be lower than the low threshold value.

The driving environment estimation apparatus of this aspect may provide hysteresis in identification either as an urban area or as a suburban area. This may prevent a change of the identification in the case of a temporary decrease of a vehicle stop time rate in an urban area or in the case of a temporary increase of the vehicle stop time rate in a suburban area. Accordingly this may prevent temporary misidentification of the driving environment and may improve the accuracy of identification.

(2) In the driving environment estimation apparatus of the above aspect, the vehicle stop degree data acquirer may obtain a rate of vehicle stop time in a predetermined time period, as the vehicle stop degree data.

This aspect may identify either as the urban area or as the suburban area, based on the rate of vehicle stop time.

(3) In the driving environment estimation apparatus of the above aspect, the vehicle stop degree data acquirer may obtain a first vehicle stop time rate that is a rate of vehicle stop time in a first time period and a second vehicle stop time that is a rate of vehicle stop time in a second time period longer than the first time period, as the vehicle stop degree data.

This aspect may identify either as the urban area or as the suburban area with good response.

(4) In the driving environment estimation apparatus of the above aspect, the urban area/suburban area identifier may provide a first high threshold value and a second high threshold value, as the high threshold value. The urban area/suburban area identifier may identify as the urban area when the first vehicle stop time rate increases from a lower value than the first high threshold value to be higher than the first high threshold value or when the second vehicle stop time rate increases from a lower value than the second high threshold value to be higher than the second high threshold value.

This aspect may promptly obtain the identification result as the urban area.

(5) In the driving environment estimation apparatus of the above aspect, the urban area/suburban area identifier may provide a first low threshold value and a second low threshold value, as the low threshold value. The urban area/suburban area identifier may identify as the suburban area when the first vehicle stop time rate decreases from a higher value than the first low threshold value to be lower than the first low threshold value and when the second vehicle stop time rate decreases from a higher value than the second low threshold value to be lower than the second low threshold value.

This aspect may obtain the identification result as the urban area with high accuracy.

(6) According to another aspect of the invention, there is provided a driving environment estimation method. The driving environment estimation method may comprise: obtaining vehicle stop degree data representing a degree of tendency of a vehicle stop state; and comparing the obtained vehicle stop degree data with a threshold value and thereby identifying whether a driving area of the vehicle is an urban area or a suburban area. The identifying whether the driving area of the vehicle is the urban area or the suburban area may comprise: providing a predetermined high threshold value and a low threshold value that is lower than the high threshold value, as the threshold value; identifying as the urban area when the vehicle stop degree data increases from a lower value than the high threshold value to be higher than the high threshold value; and identifying as the suburban area when the vehicle stop degree data decreases from a higher value than the low threshold value to be lower than the low threshold value.

The driving environment estimation method described in (6) may allow for identification either as the urban area or as the suburban area with high accuracy, like the driving environment estimation apparatus described in (1).

The invention may be implemented by any of various aspects: for example, a vehicle control apparatus including the driving environment estimation apparatus of any of the above aspects, a vehicle equipped with the driving environment estimation apparatus of any of the above aspects, a computer program that causes a computer to implement functions corresponding to the respective steps of the vehicle control method of the above aspect, and a storage medium in which such a computer program is stored.

### BRIEF DESCRIPTION OF DRAWINGS

FIG. 1 is a diagram illustrating the configuration of a motor vehicle according to one embodiment of the invention;

FIG. 2 is a diagram illustrating the functional configuration of an ECU;

FIG. 3 is a flowchart showing a target SOC estimation routine;

FIG. 4 is a diagram illustrating an SOC distribution request level calculation map;

FIG. 5 is a diagram illustrating a target SOC calculation table;

FIG. 6 is a timing chart of vehicle speed and SOC during driving of the motor vehicle;

FIG. 7 is a flowchart showing a driving environment estimation routine;

FIG. 8 is a timing chart showing a relationship between vehicle speed V and the time when a vehicle stop time acquisition routine and a vehicle stop time rate calculation routine are started;

FIG. 9 is a flowchart showing the vehicle stop time acquisition routine;

FIG. 10 is a diagram illustrating one example of a first storage stack;

FIG. 11 is a diagram illustrating a change in storage of the first storage stack;

FIG. 12 is a diagram illustrating one example of a second storage stack;

FIG. 13 is a flowchart showing the vehicle stop time rate calculation routine;

FIG. 14 is a flowchart showing an urban area/suburban area identification routine;

FIGS. 15A to 15C are graphs showing variations in near past vehicle stop time rate in a large-scale urban area, a medium- or small-scale urban area and a suburban area;

FIG. 16 is a graph showing maximum values and minimum values of the near past vehicle stop time rate in the large-scale urban area, the medium- or small-scale urban area and the suburban area;

FIGS. 17 A and 17B are graphs showing hysteresis of the near past vehicle stop time rate and a distant past vehicle stop time rate;

FIGS. 18A to 18C are graphs showing variations in distant past vehicle stop time rate in the large-scale urban area, the medium- or small-scale urban area and the suburban area; and

FIG. 19 is a graph showing maximum values and minimum values of the distant past vehicle stop time rate in the large-scale urban area, the medium- or small-scale urban area and the suburban area.

### DESCRIPTION OF EMBODIMENTS

The following describes aspects of the invention in the following sequence:

### A. General Configuration

### B. Configuration of ECU

### C. Configuration of Target SOC Estimator

### D. Driving Environment Estimation Method

### E. Advantageous Effects

### F. Modifications

### A. General Configuration

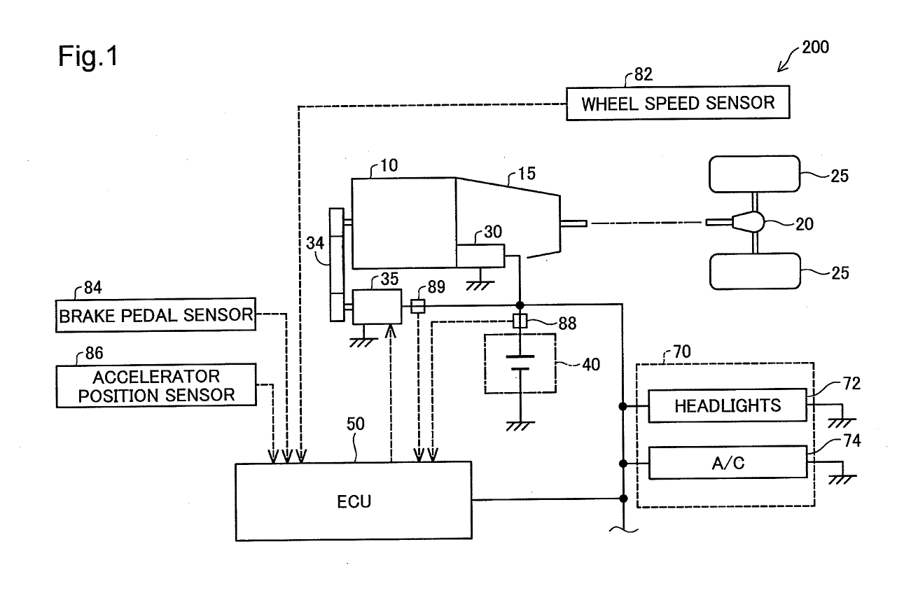

FIG. 1 is a diagram illustrating the configuration of a motor vehicle 200 according to one embodiment of the invention. The motor vehicle 200 is a vehicle having the function of idle reduction. The motor vehicle 200 includes an engine 10, an automatic transmission 15, a differential gear 20, drive wheels 25, a starter 30, an alternator 35, a battery 40 and an electronic control unit (ECU) 50.

The engine 10 is an internal combustion engine that generates power by consumption of a fuel such as gasoline or light oil. The power of the engine 10 is transmitted to the automatic transmission 15, while being transmitted to the alternator 35 via a drive mechanism 34. The output of the engine 10 is changed by an engine control computer (not shown) according to the depression amount of an accelerator pedal (not shown) operated by the driver.

The automatic transmission 15 automatically performs change of the change gear ratio (change of the gear position). The power (rotation speed×torque) of the engine 10 is subjected to gear change by the automatic transmission 15 and is transmitted as a desired rotation speed×torque via the differential gear 20 to the left and right drive wheels 25. The power of the engine 10 is accordingly transmitted via the automatic transmission 15 to the drive wheels 25 while being changed according to the depression amount of the accelerator pedal, so that the vehicle (motor vehicle 200) is accelerated or decelerated.

According to this embodiment, a belt drive configuration is employed for the drive mechanism 34 of transmitting the power of the engine 10 to the alternator 35. The alternator 35 generates electric power using part of the power of the engine 10. The alternator 35 is one type of generator. The generated electric power is used to charge the battery 40 via an inverter (not shown). In the description hereof, power generation using the power of the engine 10 by the alternator 35 is called “fuel power generation”.

The battery 40 is a lead acid battery serving as a DC power source with a voltage of 14 V and supplies electric power to a peripheral device provided other than the engine body. In the description hereof, the peripheral device provided other than the engine body and operated using the electric power of the battery 40 is called “auxiliary machine”. A group of auxiliary machines is called “auxiliary machinery”. The motor vehicle 200 includes, for example, head lights 72 and an air conditioner (A/C) 74 as auxiliary machinery 70.

The starter 30 starts the engine 10 with electric power supplied from the battery 40. According to the general procedure of starting a drive of the motor vehicle at a stop, in response to the driver's operation of an ignition switch (not shown), the starter 30 is activated to start the engine 10. This starter 30 is also used to restart the engine 10 from an idle reduction state as described later. In the description hereof, the “idle reduction state” means engine stop state by idle reduction control.

The ECU 50 includes a CPU that executes a computer program, a ROM that stores, for example, the computer program, a RAM that temporarily stores data and input and output ports connected with, for example, various sensors and actuators. The sensors connected with the ECU 50 may be, for example, a wheel speed sensor 82 configured to detect the rotating speed of the drive wheels 25, a brake pedal sensor 84 configured to detect depression or non-depression of a brake pedal (not shown), an accelerator position sensor 86 configured to detect the depression amount of the accelerator pedal (not shown) as an accelerator position or accelerator opening, a battery current sensor 88 configured to detect charge-discharge current of the battery 40 and an alternator current sensor 89 configured to detect output current of the alternator 35. The starter 30 and the alternator 35 are examples of the actuator. The ECU 50 receives supply of electric power from the battery 40.

The ECU 50 controls the starter 30 and the alternator 35 in response to signals from the various sensors described above and the engine control computer (not shown), so as to control stop and restart of the engine and control the SOC of the battery 40. Such control of stopping and restarting the engine is called idle reduction control.

### B. Configuration of ECU

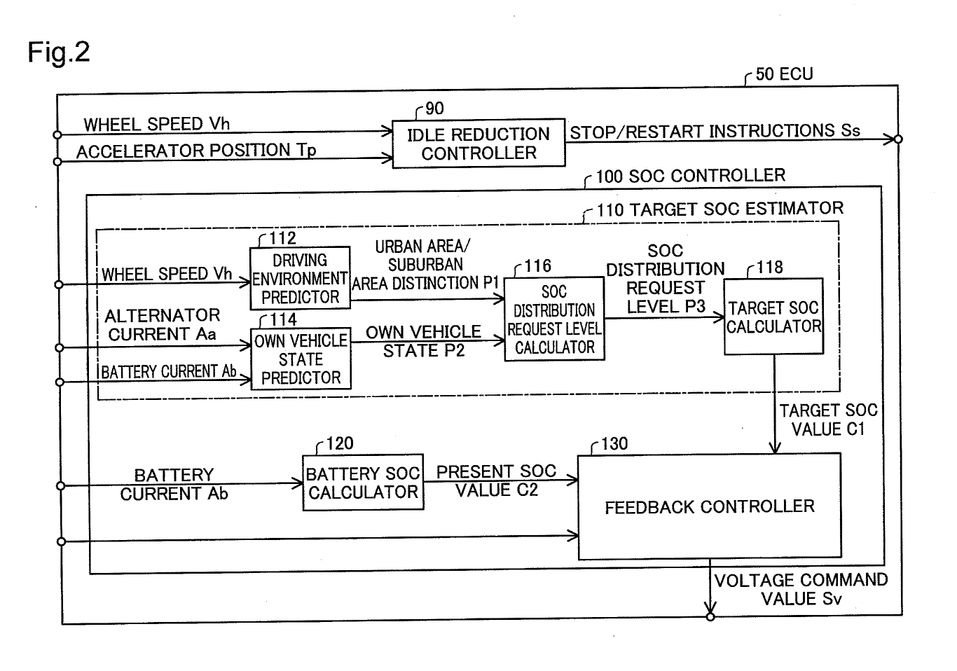

FIG. 2 is a diagram illustrating the functional configuration of the ECU 50. As illustrated, the ECU 50 includes an idle reduction controller 90 and an SOC controller 100. The idle reduction controller 90 and the SOC controller 100 actually represent the functions implemented by execution of the computer program stored in the ROM by the CPU included in the ECU 50.

The idle reduction controller 90 obtains a wheel speed Vh detected by the wheel speed sensor 82 and an accelerator position Tp detected by the accelerator position sensor 86 and outputs stop/restart instructions Ss to stop and restart the engine 10. The stop/restart instructions Ss include an engine restart instruction to be output to the starter 30 and a fuel cutoff instruction to be output to a fuel supply system (not shown) of the engine 10. More specifically, when the wheel speed Vh decreases below a predetermined speed (for example, 10 km/h), the idle reduction controller 90 determines that an engine stop condition is satisfied and outputs the fuel cutoff instruction to the fuel supply system. When depression of the accelerator pedal is detected subsequently based on the accelerator position Tp, the idle reduction controller 90 determines that an engine restart condition is satisfied and outputs the engine restart instruction to the starter 30.

In other words, the idle reduction controller 90 stops the engine 10 upon satisfaction of the engine stop condition and restarts the engine 10 upon satisfaction of the engine restart condition after the engine stop. The engine stop condition and the engine restart condition are not limited to those described above. For example, the engine stop condition may be that the wheel speed Vh is completely decreased to 0 km/h, and the engine restart condition may be that the driver takes the foot off the brake pedal.

The SOC controller 100 includes a target SOC estimator 110, a battery SOC calculator 120 and a feedback controller 130. The target SOC estimator 110 estimates an SOC expected to be used in a time period from an engine stop to an engine restart by the idle reduction control (hereinafter called “stop and start period”) during running of the vehicle (for example, at the wheel speed Vh>0 km/h), as a target SOC (hereinafter also called “target SOC value”) C1. The detailed configuration will be described in Section C. The “SOC” is defined as a value obtained by dividing the quantity of electricity remaining in the battery by the quantity of electricity accumulated at the full charge level of the battery.

The battery SOC calculator 120 calculates a present SOC (hereinafter called “present SOC value”) C2, based on charge-discharge current Ab of the battery 40 (called “battery current”) detected by the battery current sensor 88. More specifically, the present SOC value C2 is calculated by integrating the charge-discharge current Ab with the charge current of the battery 40 as positive values and the discharge current of the battery 40 as negative values. The configuration of the battery current sensor 88 and the battery SOC calculator 120 is included in the configuration of the “SOC detector” described in Solution to Problem. The SOC detector is not limited to the configuration of calculating the SOC based on the battery current detected by the battery current sensor 88 but may calculate the SOC based on, for example, a battery electrolytic solution specific gravity sensor, a cell voltage sensor or a battery terminal voltage sensor. Additionally, the SOC detector is not limited to the configuration of detecting the quantity of electricity remaining in the battery but may detect the state of charge by another parameter, for example, a chargeable amount.

The feedback controller 130 calculates a difference value by subtracting the present SOC value C2 from the target SOC value C1 during running of the vehicle and determines a voltage command value Sv to make the difference value approach to the value 0 by feedback control. The voltage command value Sv denotes an instruction to specify the amount of power to be generated by the alternator 35 and is sent to the alternator 35. This results in controlling the present SOC value C2 to the target SOC value C1 by the fuel power generation.

The SOC controller 100 has a function called “battery control” and a function called “charge control” in addition to those described above, although not being illustrated. The battery control is described. With respect to the battery or more specifically the lead acid battery of the embodiment, the usable SOC range (operable SOC range) is determined in advance in terms of a demand for long life. Accordingly, the “battery control” is performed to increase the power of the engine 10 to make the SOC in the above SOC range when the SOC of the battery 40 decreases below a lower limit (for example, 60%) of the SOC range and consume the SOC to make the SOC in the above SOC range when the SOC of the battery 40 increases above an upper limit (for example, 90%) of the SOC range. When the SOC decreases below the lower limit even in the engine stop state by idle reduction control, the engine is started to perform the fuel power generation and make the SOC in the above SOC range.

The “charge control” denotes control that suppresses the battery from being charged by the fuel power generation during ordinary running to save the fuel consumption and charges the battery by regenerative power generation during deceleration running. The charge control is the known configuration and is thus not described in detail but is described only briefly. The charge control activates the feedback control by the feedback controller 130 during ordinary running when the target SOC value C1 is higher than the present SOC value C2, and sets a specified power generation cutoff voltage to the voltage command value Sv to be given to the alternator 35 when the target SOC value C1 is equal to or lower than the present SOC value C2 during ordinary running. This configuration suppresses charging during ordinary running and saves the fuel consumption. The “ordinary running” denotes a state of the motor vehicle 200 other than the state of “vehicle stop” in which the vehicle speed is 0 km/h and the state of “deceleration running” in which the regenerative power generation is performed.

### C. Configuration of Target SOC Estimator

The target SOC estimator 110 includes a driving environment predictor 112, an own vehicle state predictor 114, an SOC distribution request level calculator 116 and a target SOC calculator 118.

The driving environment predictor 112 predicts the driving environment of the vehicle. According to this embodiment, the “driving environment” indicates distinction of whether the future (after the present moment) vehicle driving area is an urban area or a suburban area. The driving environment predictor 112 identifies whether the driving environment up to the present moment is an urban area or a suburban area, based on the wheel speed Vh detected by the wheel speed sensor 82, and outputs the result of identification as an urban area/suburban area distinction P1 of the future (after the present moment) driving area. The urban area/suburban area distinction P1 may take the value 1 for the urban area and the value 0 for the suburban area. A detailed method of identifying (estimating) whether the driving area is an urban area or a suburban area will be described in Section D.

The own vehicle state predictor 114 predicts the state of the motor vehicle 200 (own vehicle state). The “own vehicle state” herein denotes a parameter estimating the degree of future consumption of the SOC by the motor vehicle 200. More specifically, the own vehicle state predictor 114 estimates the amount of electric power expected to be consumed by the auxiliary machinery 70, based on the battery current Ab detected by the battery current sensor 88 and an alternator current Aa detected by the alternator current sensor 89, and outputs the estimated amount of electric power as an own vehicle state P2. When a large amount of electric power is expected to be consumed by the auxiliary machinery 70, the SOC is consumed at a high rate. According to this embodiment, the own vehicle state predictor 114 thus specifies the amount of electric power expected to be consumed by the auxiliary machinery 70 as the own vehicle state P2.

This embodiment estimates the own vehicle state P2 based on the amount of electric power expected to be consumed by the auxiliary machinery 70, but the invention is not limited to this configuration. For example, another available configuration may estimate the own vehicle state P2, based on air-conditioning information correlated to the power consumption of the air conditioner (A/c), such as a difference between target temperature and vehicle interior temperature, or based on information regarding the warm-up state of the engine, such as a difference between engine water temperature and environment temperature. The available configuration is not limited to the configuration of estimating the own vehicle state P2 based on one parameter selected among, for example, the amount of electric power expected to be consumed by the auxiliary machinery 70, the air-conditioning information and the warm-up state information, but may be a configuration of estimating the own vehicle state P2 based on two or more parameters. In an application using two or more parameters, a preferable configuration estimates the own vehicle state P2 by multiplying the respective parameters by individual weighting factors.

Any of the configurations described above determines the present operating state of the auxiliary machinery based on the presently detected sensor signals and regards the present operating state as the future own vehicle state. Alternatively, an available configuration may estimate the future own vehicle state by reading an indication of changing the operating state from the present operating state determined as described above.

The driving environment predictor 112 and the own vehicle state predictor 114 of the above configuration continuously perform the predictions after a start of driving the motor vehicle 200. The respective modules 122 to 124 are implemented by execution of the computer program stored in the ROM by the CPU included in the ECU 50. The urban area/suburban area distinction P1 estimated by the driving environment predictor 112 and the own vehicle state P2 estimated by the own vehicle state predictor 114 are sent to the SOC distribution request level calculator 116.

The SOC distribution request level calculator 116 calculates an SOC distribution request level P3, based on the urban area/suburban area distinction P1 and the own vehicle state P2. The target SOC calculator 118 calculates the target SOC value C1, based on the SOC distribution request level P3. The following describes the configuration of the SOC distribution request level calculator 116 and the target SOC calculator 118 in detail.

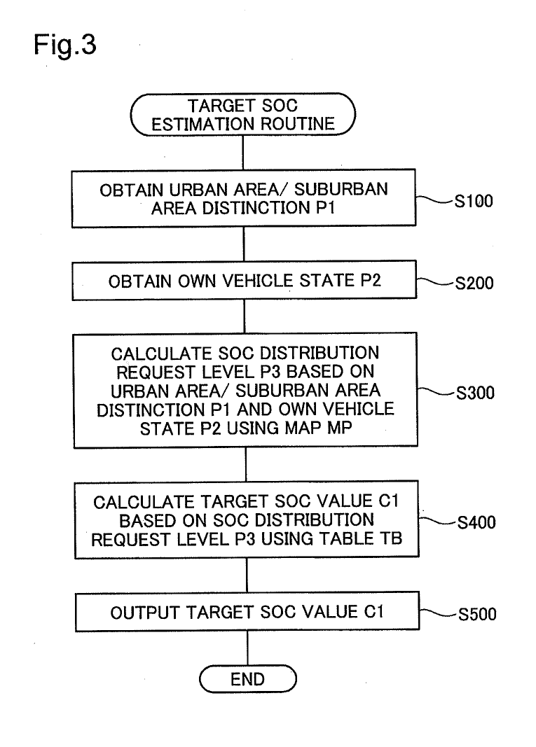

FIG. 3 is a flowchart showing a target SOC estimation routine. This target SOC estimation routine is performed repeatedly at predetermined time intervals (for example, at every 60 sec) during running of the vehicle. In other words, the target SOC estimation routine is not performed in the state of stopping the engine 10 by the idle reduction control. As illustrated, on the start of the processing flow, the CPU of the ECU 50 obtains the urban area/suburban area distinction P1 estimated by the driving environment predictor 112 (FIG. 2) (step S100) and obtains the own vehicle state P2 estimated by the own vehicle state predictor 114 (FIG. 2) (step S200).

After the processing of step S200, the CPU calculates an SOC distribution request level based on the urban area/suburban area distinction P1 and the own vehicle state P2 using an SOC distribution request level calculation map MP (step S300). As mentioned above, the usable SOC range is determined for each type of the battery. According to this embodiment, the usable SOC range is to be distributed into a range for idle reduction and a range for charge control. The “SOC distribution request level” denotes a parameter specifying this distribution level.

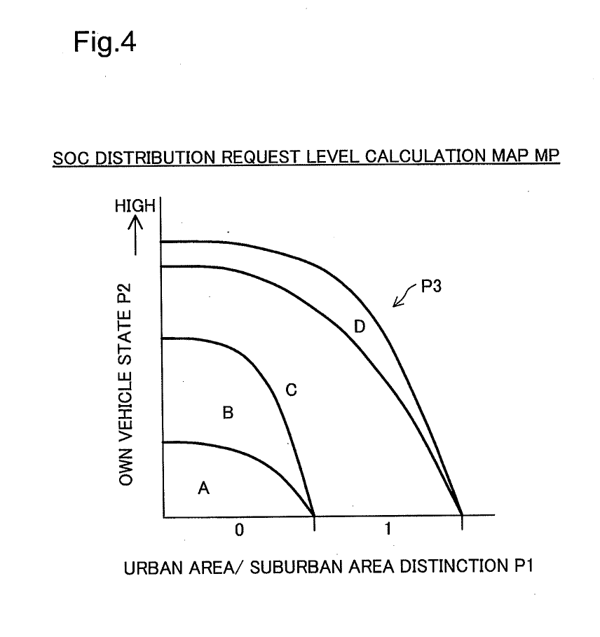

FIG. 4 is a diagram illustrating the SOC distribution request level calculation map MP. As illustrated, the SOC distribution request level calculation map MP is map data having the urban area/suburban area distinction P1 as abscissa and the own vehicle state P2 as ordinate and mapping the SOC distribution request level P3 corresponding to the values of the abscissa and the ordinate. The SOC distribution request level calculation map MP is created by determining a relationship among the urban area/suburban area distinction P1, the own vehicle state P2 and the SOC distribution request level P3 in advance by experiment or by simulation and is stored in the ROM. At step S300, the CPU reads the SOC distribution request level calculation map MP from the ROM and refers to this map MP to obtain the SOC distribution request level P3 corresponding to the urban area/suburban area distinction P1 obtained at step S100 and the own vehicle state P2 obtained at step S200. In the illustrated example, four values A, B, C and D are provided as the SOC distribution request level P3. These values decrease in the order of D, C, B and A; i.e., D>C>B>A. The urban area/suburban area distinction P1 equal to the value 1 representing the urban area has the higher SOC distribution request level P3 than the urban area/suburban area distinction P1 equal to the value 0 representing the suburban area. The higher own vehicle state P2 gives the higher SOC distribution request level P3.

Referring back to FIG. 3, after the processing of step S300, the CPU calculates the target SOC value C1 based on the SOC distribution request level P3 using a target SOC calculation table TB (step S400).

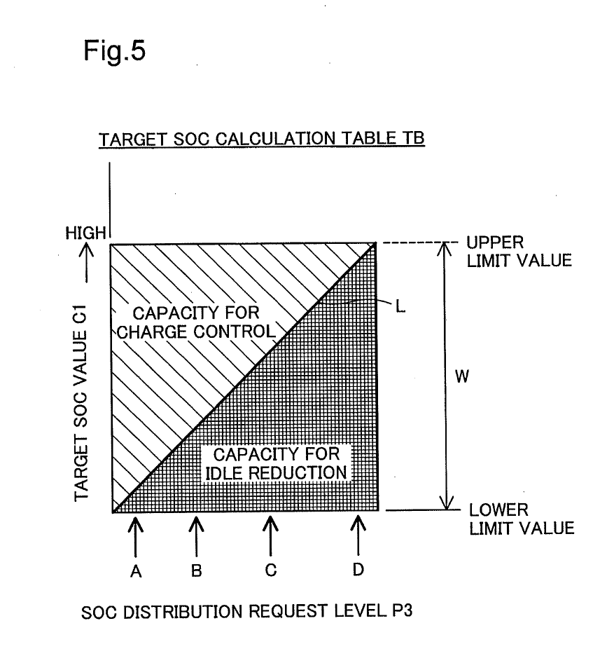

FIG. 5 is a diagram illustrating the target SOC calculation table TB. As illustrated, the target SOC calculation table TB has the SOC distribution request level P3 as abscissa and the target SOC value C1 as ordinate. A straight line L indicates a relationship between the SOC distribution request level P3 and the target SOC value C1. The target SOC calculation table TB is created by determining the relationship between the SOC distribution request level P3 and the target SOC value C1 in advance by experiment or by simulation and is stored in the ROM. At step S400, the CPU reads the target SOC calculation table TB from the ROM and refers to this table TB to obtain the target SOC value C1 corresponding to the SOC distribution request level P3 calculated at step S300.

As illustrated, the target SOC value C1 shown by the straight line L is set in a usable SOC range W of the battery 40 and shows a distribution rate at which the usable SOC range W is distributed into capacity for charge control and capacity for idle reduction. In other words, a capacity area for idle reduction is set on the lower side and a capacity area for charge control is set on the upper side in the usable SOC range W of the battery 40. The boundary between these two capacity areas indicates the target SOC value C1. In another way, a level by adding the capacity for idle reduction to a lower limit value of the usable SOC range W is set to the target SOC value C1.

The capacity for charge control denotes a battery capacity required by suppression of the fuel power generation by the charge control described above. The capacity for idle reduction denotes a capacity expected to be used in the future stop and start period. According to this embodiment, the capacity for idle reduction is set to an expected maximum value. The higher SOC distribution request level P3 gives the higher capacity for idle reduction. Controlling the SOC to the upper side of the straight line L causes the remaining capacity corresponding to the controlled SOC in the usable SOC range to exceed the capacity for idle reduction. This ensures complete idle reduction control, but this surplus is excessive. The target SOC value C1 shown by the straight line L accordingly shows the SOC value that ensures complete future idle reduction and minimizes the amount of power generation for accumulation of the SOC.

The target SOC value C1 linearly increases with an increase in SOC distribution request level P3 as shown by the straight line L, but the invention is not limited to this configuration. For example, one modified configuration may linearly increase the target SOC value C1 with an increase in SOC distribution request level P3 when the SOC distribution request level P3 is equal to or lower than a specified value and keep the target SOC value C1 at a constant level when the SOC distribution request level P3 is higher than the specified value. This modified configuration is advantageous for a battery having a relatively narrow usable SOC range. Moreover, the configuration that shows a change of the target SOC value C1 by a straight line may be replaced with a configuration that uses a curved line.

Referring back to FIG. 3, after the processing of step S400, the CPU outputs the target SOC value C1 calculated at step S400 to the feedback controller 130 (step S500) and subsequently terminates the target SOC estimation routine. The feedback controller 130 (FIG. 2) then controls the present SOC value C2 to the calculated target SOC value C1. The present SOC value C2 indicates the remaining capacity in the usable SOC range of the battery 40. Such controlling results in preventing the remaining capacity from decreasing below the capacity for idle reduction during running of the vehicle. More specifically, in FIG. 5, when the present SOC value is located in the capacity area for charge control, i.e., when the remaining capacity exceeds the capacity for idle reduction, charge control is performed to suppress charging into the battery 40 by the fuel power generation. When the SOC decreases to the capacity for idle reduction, fuel power generation is performed to control the SOC to the target SOC value C1 shown by the straight line L. This prevents the SOC from decreasing below the capacity for idle reduction.

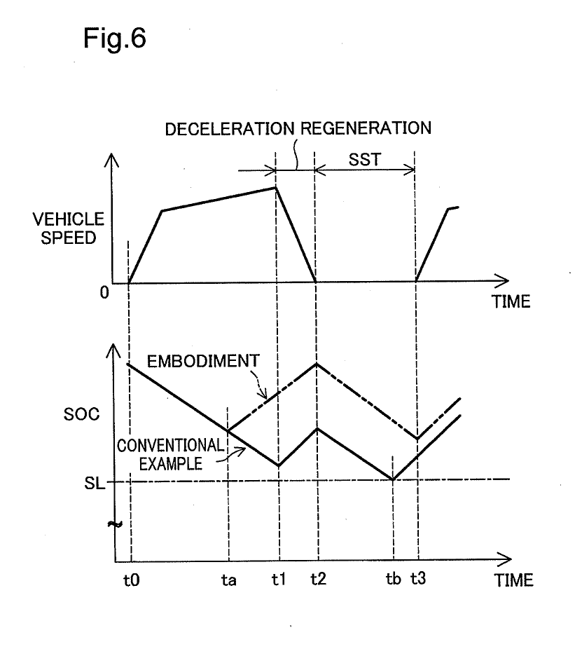

FIG. 6 is a timing chart of the vehicle speed and the SOC (present SOC value C2) of the battery 40 during driving of the motor vehicle 200. The timing chart has the vehicle speed and the SOC as ordinate and the time as abscissa. When the motor vehicle 200 is driven to start at a time t0, the vehicle speed gradually increases to the ordinary running level. The vehicle then shifts to the deceleration state at a time t1. In a t0-t1 period from the time t0 to the time t1, the SOC gradually decreases as shown by a solid-line graph with respect to a conventional example. In this embodiment, however, the SOC changes as shown by a two-dot chain-line graph as described later.

The vehicle stops at a time t2 after the time t1. Regenerative power generation by deceleration is performed in a t1-t2 period, so that the SOC gradually increases as shown by the solid-line graph. A period from the time t2 (more strictly, the time when the engine stop condition is satisfied) to a time t3 when the vehicle speed rises is a stop and start period SST, in which the engine 10 is at stop. In the stop and start period SST, the SOC gradually decreases by power consumption by the auxiliary machinery. In the conventional example, as shown by the solid-line graph, when the SOC reaches a lower limit value SL (time tb) in the engine stop state, the battery control is performed to restart the engine 10. After the restart, the SOC increases by power generation using the power of the engine 10 as shown by the solid-line graph.

According to this embodiment, when the SOC decreases during ordinary running and the remaining capacity in the usable SOC range of the battery 40 decreases below the capacity for idle reduction (time ta), fuel power generation is performed to increase the SOC. The SOC increases in a ta-t2 period as shown by the two-dot chain-line graph of FIG. 2. This increase is on the premise of a maximum battery capacity expected to be used in a future stop and start period. Even when the SOC decreases in the stop and start period t2-t3, the SOC does not reach the lower limit value SL. The “future stop and start period” is not limited to one stop and start period SST illustrated but includes all stop and start periods if a plurality of stop and start periods are present in a predetermined time period. Unlike the conventional example, this embodiment prevents the SOC from reaching the lower limit value to restart the engine 10 in the stop and start period t2-t3.

### D. Driving Environment Estimation Method

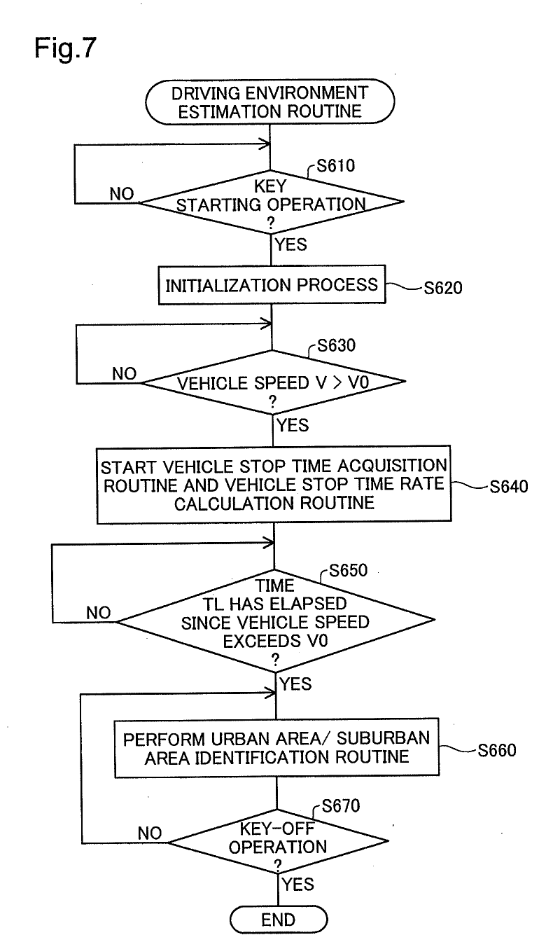

FIG. 7 is a flowchart showing a driving environment estimation routine. The CPU of the ECU 50 performs the driving environment estimation routine to identify (estimate) whether the driving environment up to the present moment is an urban area or a suburban area. The function implemented by execution of this driving environment estimation routine is included in the driving environment predictor 112 (FIG. 2).

As shown in FIG. 7, on the start of the processing flow, the CPU of the ECU 50 first determines whether a key starting operation is performed (step S610). The “key starting operation” denotes starting the engine in response to the driver's operation of an ignition key (not shown). When it is determined that the key starting operation is not performed at step S610, the CPU repeats the processing of step S610 and waits for a key starting operation. When the key starting operation is performed, the CPU performs an initialization process that clears storage stacks and variables described later (step S620). One of the variables is the urban area/suburban area distinction P1 described later. The urban area/suburban area distinction P1 is cleared to the value 0 representing a suburban area.

The CPU subsequently sets the wheel speed Vh detected by the wheel speed sensor 82 to the vehicle speed V and determines whether the vehicle speed V exceeds a predefined speed V0 (for example, 15 km/h) (step S630). When the vehicle speed V is equal to or lower than V0, the CPU waits until the vehicle speed V exceeds V0 and then shifts the processing flow to step S640. The vehicle speed V used here may be a detection value of a vehicle speed sensor (not shown), instead of the detection value of the wheel speed sensor 82. At step S640, the CPU starts a vehicle stop time acquisition routine and a vehicle stop time rate calculation routine.

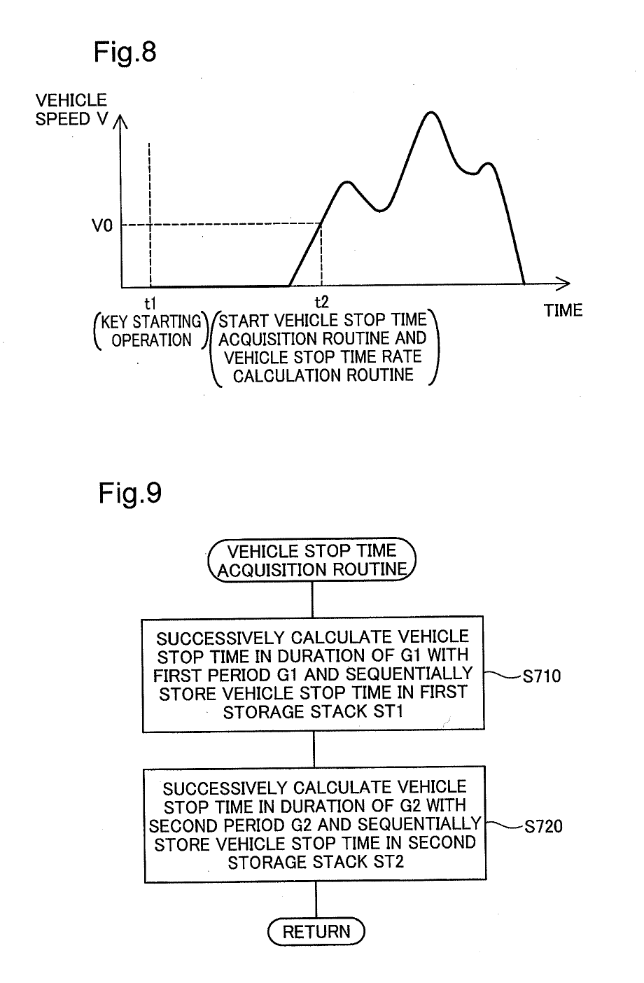

FIG. 8 is a timing chart showing a relationship between the vehicle speed V and the time when the vehicle stop time acquisition routine and the vehicle stop time rate calculation routine are started. The timing chart has the time t as abscissa and the vehicle speed V as ordinate. As illustrated, when the key starting operation is performed at a time t1, the vehicle speed is kept at 0 km/h for a predetermined time period since the key starting operation, because of, for example, catalyst warmup. The vehicle speed V then rises and reaches the predefined speed V0. At a time t2 when the vehicle speed V reaches the predefined speed V0, the vehicle stop time acquisition routine and the vehicle stop time rate calculation routine are started. In this configuration, a time period from the time of the key starting operation to the time when the vehicle speed V reaches the predefined speed V0 (t1-t2 period) is not counted as a vehicle stop time obtained by the vehicle stop time acquisition routine.

Referring back to FIG. 7, after the processing of step S640, the CPU determines whether a starting time limit (TL described later) has elapsed since the vehicle speed V exceeds V0 (step S650). The CPU waits for elapse of the starting time limit TL and performs an urban area/suburban area identification routine described later (step S660). After the processing of step S660, the CPU determines whether the driver performs a key-off operation to turn off the ignition key (step S670). The CPU repeats the processing of step S660 until the key-off operation. In response to the key-off operation, the CPU terminates this driving environment estimation routine.

FIG. 9 is a flowchart showing the vehicle stop time acquisition routine started at step S640. On the start of the processing flow, the CPU repeatedly performs a vehicle stop time acquisition process described below with a first period G1 (step S710). The vehicle stop time acquisition process calculates a vehicle stop time in duration of the first period G1 and stores the calculated vehicle stop time in a first storage stack ST1. The first period G1 is 60 [sec].

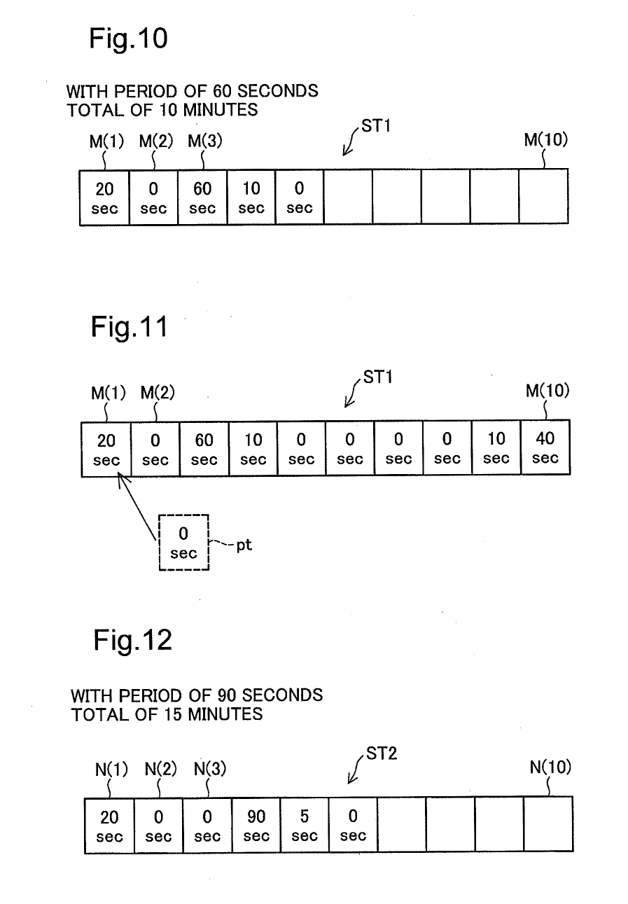

FIG. 10 is a diagram illustrating one example of the first storage stack ST1. As illustrated, the first storage stack ST1 is comprised of ten stack elements M(1), M(2), . . . , M(10). At step S710, the CPU calculates the vehicle stop time in the duration of 60 seconds with the period of 60 seconds and successively stores the calculated results in the stack elements M(n) of the first storage stack ST1, where n is a variable from 1 to 10. The stack element M(n) in which the vehicle stop time is stored sequentially shifts from M(1) to M(n). The procedure of calculating the vehicle stop time determines whether the vehicle is at stop (Vh=0 km/h) based on the wheel speed Vh detected by the wheel speed sensor 82 and measures the vehicle stop time in the duration of the first period G1. The detection value of the vehicle speed sensor (not shown) may be used, instead of the detection value of the wheel speed sensor 82, for determining whether the vehicle is at stop.

At step S710, the CPU successively determines the vehicle stop time in the duration of 60 seconds with the period of 60 seconds and sequentially stores the determined vehicle stop times one by one from the stack element M(1) to the stack element M(10). In the illustrated example, a vehicle stop time of 20 seconds is stored in the stack element M(1) after elapse of 60 seconds; a vehicle stop time of 0 second is stored in the stack element M(2) after elapse of 120 seconds; and a vehicle stop time of 60 seconds is stored in the stack element M(3) after elapse of 180 seconds. In this way, the vehicle stop times are sequentially stored with the period of 60 seconds. When the last stack element M(10) is occupied with storage of the vehicle stop time, i.e., when the total of 10 minutes (600 seconds) has elapsed, a vehicle stop time pt obtained in a next period is stored in the first stack element M(1) as shown in FIG. 11. The stack elements M(2) to M(10) keep the stored values. A vehicle stop time obtained in a subsequent period (not shown) is stored in the second stack element M(2). In this way, when all the stack elements to M(10) have been occupied, the stack element used for storage is returned to the first stack element, and the storage is updated sequentially one by one from the first stack element.

Referring back to FIG. 9, the CPU repeatedly performs a vehicle stop time acquisition process described below with a second period G2 (step S720). The vehicle stop time acquisition process calculates a vehicle stop time in duration of the second period G2 and stores the calculated vehicle stop time in a second storage stack ST2. The second period G2 is 90 [sec]. The processing of step S720 is shown as the processing subsequent to the processing of step S710 in the illustration. This is only for convenience of illustration. In the actual state, like the processing of step S710 described above, the processing of step S720 is performed immediately after the start of the vehicle stop time acquisition routine. In other words, the processing of step S710 and the processing of step S720 are performed in parallel by time sharing.

FIG. 12 is a diagram illustrating one example of the second storage stack ST2. As illustrated, the second storage stack ST2 is comprised of ten stack elements N(1), N(2), . . . , N(10). At step S720, the CPU calculates the vehicle stop time in the duration of 90 seconds with the period of 90 seconds and successively stores the calculated results in the stack elements N(n) of the second storage stack ST2, where n is a variable from 1 to 10. The stack element N(n) in which the vehicle stop time is stored sequentially shifts from N(1) to N(n). As described above, the procedure of calculating the vehicle stop time detects a vehicle stop based on the wheel speed Vh detected by the wheel speed sensor 82 and measures the vehicle stop time in the duration of the second period G2.

At step S720, the CPU successively determines the vehicle stop time in the duration of 90 seconds with the period of 90 seconds and sequentially stores the determined vehicle stop times one by one from the stack element N(1) to the stack element N(10). In the illustrated example, a vehicle stop time of 20 seconds is stored in the stack element N(1) after elapse of 90 seconds; a vehicle stop time of 0 second is stored in the stack element N(2) after elapse of 180 seconds; and a vehicle stop time of 0 second is stored in the stack element N(3) after elapse of 270 seconds. In this way, the vehicle stop times are sequentially stored with the period of 60 seconds. When the last stack element N(10) is occupied with storage of the vehicle stop time, i.e., when the total of 15 minutes (900 seconds) has elapsed, the stack element used for storage is returned to the first stack element, and the storage is updated sequentially one by one from the first stack element, like the first storage stack ST1.

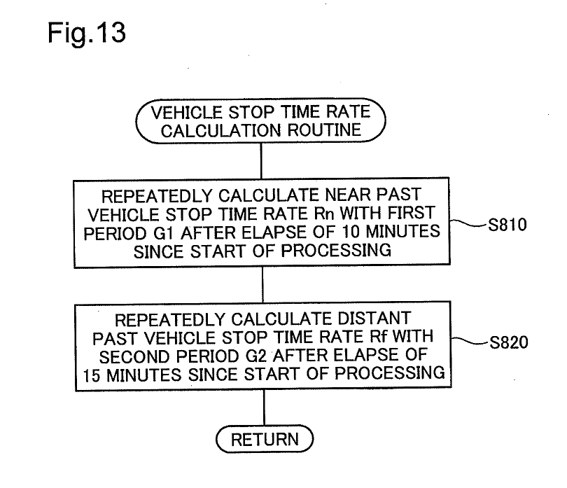

FIG. 13 is a flowchart showing the vehicle stop time rate calculation routine started at step S640 (FIG. 7). On the start of the processing flow, the CPU repeatedly calculates a near past vehicle stop time rate Rn with the first period G1 after elapse of 10 minutes since the start of the processing (step S810). More specifically, the CPU calculates a total of the respective values stored in the stack elements M(1) to M(10) of the first storage stack ST1, divides the total by 600 seconds which is the time required for occupying the first storage stack ST1, and sets the quotient to the near past vehicle stop time rate Rn. In the first storage stack ST1, the stack elements M(n) are updated one by one at every 60 seconds which is the first period G1. The near past vehicle stop time rate Rn is accordingly calculated at every update. In other words, the processing of step S810 uses the storage of the first storage stack ST1 and calculates the rate of the vehicle stop time in the recent past of 600 seconds as the near past vehicle stop time rate Rn. The rate of the vehicle stop time denotes the rate of the vehicle stop time to the entire time (600 seconds).

The CPU repeatedly calculates a distant past vehicle stop time rate Rf with the second period G2 after elapse of 15 minutes since the start of the processing (step S820). The processing of step S820 is shown as the processing subsequent to the processing of step S810 in the illustration. This is only for convenience of illustration. In the actual state, like the processing of step S810 described above, the processing of step S820 is performed immediately after the start of the vehicle stop time rate calculation routine. In other words, the processing of step S810 and the processing of step S820 are performed in parallel by time sharing.

More specifically, at step S820, the CPU calculates a total of the respective values stored in the stack elements N(1) to N(10) of the second storage stack ST2, divides the total by 900 seconds which is the time required for occupying the second storage stack ST2, and sets the quotient to the distant past vehicle stop time rate Rf. In the second storage stack ST2, the stack elements N(n) are updated one by one at every 90 seconds which is the second period G2. The distant past vehicle stop time rate Rf is accordingly calculated at every update. In other words, the processing of step S820 uses the storage of the second storage stack ST2 and calculates the rate of the vehicle stop time in the recent past of 900 seconds as the distant past vehicle stop time rate Rf. The rate of the vehicle stop time denotes the rate of the vehicle stop time to the entire time (900 seconds). The time required for occupying the second storage stack ST2, i.e., 900 seconds, corresponds to the starting time limit TL at step S650 described above.

The near past vehicle stop time rate Rn is included in the “first vehicle stop time rate” described in Solution to Problem, and the distant past vehicle stop time rate Rf is included in the “second vehicle stop time rate” described in Solution to Problem. The near past vehicle stop time rate Rn and the distant past vehicle stop time rate Rf are also included in the “vehicle stop degree data” described in Solution to Problem. The ECU 50 and the configuration of the vehicle stop time acquisition routine and the vehicle stop time rate calculation routine performed by the CPU of the ECU 50 are included in the “vehicle stop degree data acquirer” described in Solution to Problem.

As described above, the near past vehicle stop time rate Rn is calculated after elapse of 10 minutes since the start of the processing, and the distant past vehicle stop time rate Rf is calculated after elapse of 15 minutes since the start of the processing. This waits for the time periods to settle the respective first values using the first and the second storage stacks ST1 and ST2. The waiting time periods may be set to predetermined initial values required by the system.

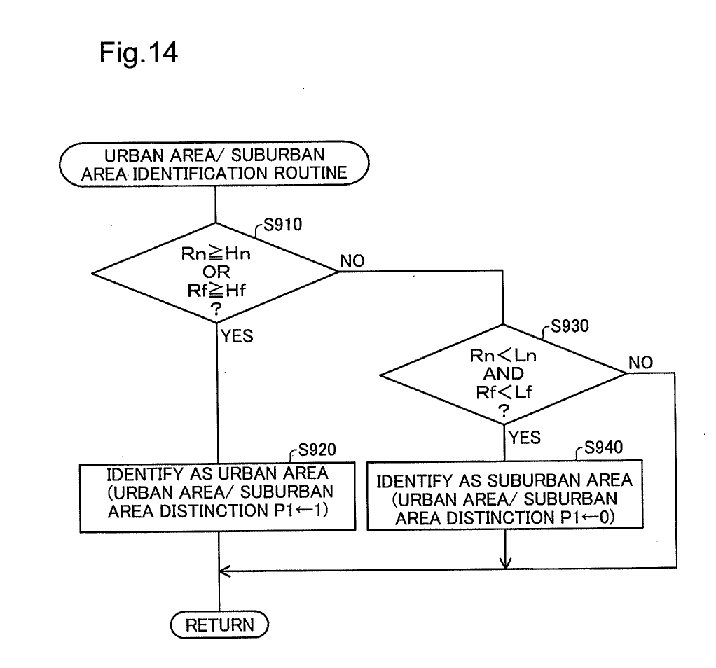

FIG. 14 is a flowchart showing the urban area/suburban area identification routine performed at step S660 (FIG. 7). This urban area/suburban area identification routine compares the latest near past vehicle stop time rate Rn and the latest distant past vehicle stop time rate Rf obtained in the vehicle stop time rate calculation routine with threshold values and thereby identifies whether the driving environment is an urban area or a suburban area. The ECU and the configuration of the urban area/suburban area identification routine performed by the CPU of the ECU 50 are included in the “urban area/suburban area identifier” described in Solution to Problem.

In this urban area/suburban area identification routine, four threshold values are provided as the threshold values used for such identification. More specifically, two higher threshold values (high threshold values) used to identify an urban area are provided as the threshold values for the near past vehicle stop time rate Rn and for the distant past vehicle stop time rate Rt, and two lower threshold values (low threshold values) used to identify a suburban area are provided as the threshold values for the near past vehicle stop time rate Rn and for the distant past vehicle stop time rate Rt. The former two threshold values are a first high threshold value Hn and a second high threshold value Hf, and the latter two threshold values are a first low threshold value Ln and a second low threshold value Lf. These threshold values Hn, Hf, Ln and Lf are predetermined values.

As illustrated, on the start of the processing flow, the CPU determines whether at least one of conditions that the near past vehicle stop time rate Rn is equal to or higher than the first high threshold value Hn and that the distant past vehicle stop time rate Rf is equal to or higher than the second high threshold value Hf is satisfied (step S910). The first high threshold value Hn and the second high threshold value Hf has the relation of Hn>Hf. For example, Hm is 47%, and Hf is 39%. When it is determined at step S910 that at least one of the conditions is satisfied, the CPU identifies the driving environment as an urban area (step S920). In other words, the urban area/suburban area distinction P1 is set to the value 1. After the processing of step S920, the CPU goes to “Return” and terminates this routine.

When it is determined at step S910 that neither of the above two conditions is satisfied, on the other hand, the CPU determines whether both conditions that the near past vehicle stop time rate Rn is lower than the first low threshold value Ln and that the distant past vehicle stop time rate Rf is lower than the second low threshold value Lf are satisfied (step S930). The first low threshold value Ln and the first high threshold value Hn have the relation of Hn>Ln. The second low threshold value Lf and the second high threshold value Hf have the relation of Hf>Lf. For example, Ln is 34%, and Lf is 33%. The first low threshold value Ln and the second low threshold value Lf have the relation of Ln>Lf. Accordingly, this embodiment has the relation of Hn>Hf>Ln>Lf.

When it is determined at step S930 that both the conditions are satisfied, the CPU identifies the driving environment as a suburban area (step S940). In other words, the urban area/suburban area distinction P1 is set to the value 0. After the processing of step S940, the CPU goes to “Return” and terminates this routine. Upon negative determination at step S930, i.e., when it is determined at step S930 that at least one of the conditions is not satisfied, the CPU immediately goes to “Return” and terminates this routine. In other words, upon negative determination at step S930, the CPU keeps the previous value of the urban area/suburban area distinction P1 set in the previous cycle and terminates the routine.

The algorithm according to the urban area/suburban area identification routine of the above configuration identifies whether the driving environment is an urban area or a suburban area based on the near past vehicle stop time rate Rn and the distant past vehicle stop time rate Rf. The following describes the reason for the configuration of this algorithm.

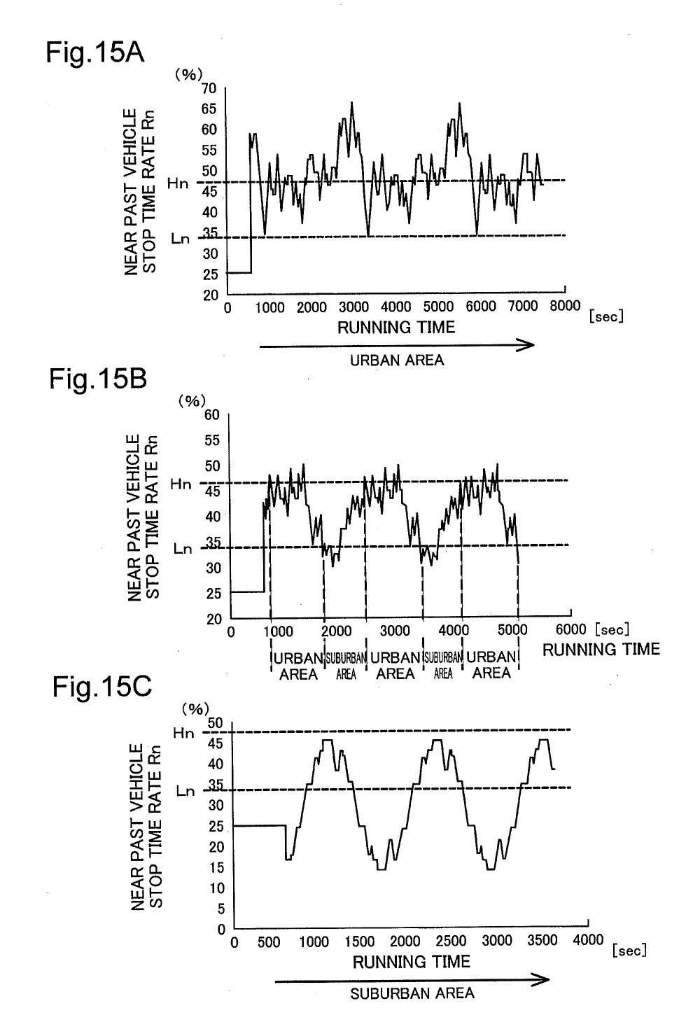

FIGS. 15A to 15C are graphs showing variations in near past vehicle stop time rate Rn in a large-scale urban area, a medium- or small-scale urban area and a suburban area. These graphs show the variations in near past vehicle stop time rate Rn obtained by actually driving a motor vehicle in the large-scale urban area, the medium- or small-scale urban area and the suburban area. The respective graphs have the running time as abscissa and the near past vehicle stop time rate Rn as ordinate.

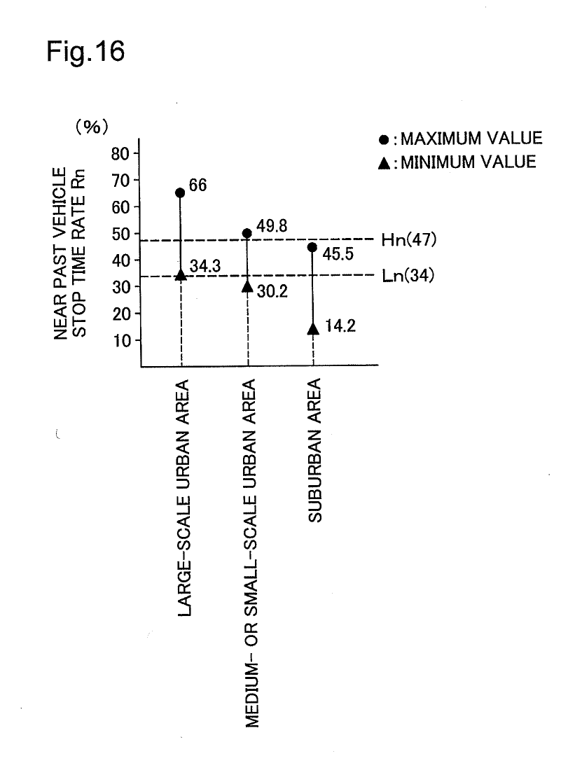

FIG. 16 is a graph showing maximum values and minimum values of the near past vehicle stop time rate Rn in the large-scale urban area, the medium- or small-scale urban area and the suburban area. The closed circle represents the maximum value, and the closed triangle represents the minimum value in the graph. The respective maximum and minimum values are read from the graphs of FIGS. 15(a), 15(b) and 15(c).

As shown in FIG. 16, the distribution of the near past vehicle stop time rate Rn in the large-scale urban area is 34.3 to 66%. The distribution of the near past vehicle stop time rate Rn in the medium- or small-scale urban area is 30.2 to 49.8%. The distribution of the near past vehicle stop time rate Rn in the suburban area is 14.2 to 45.5%. These results show that the respective distributions of the near past vehicle stop time rate Rn in the large-scale urban area, the medium- or small-scale urban area and the suburban area cover wide ranges and are partly overlapped with one another. Accordingly, it is unreasonable to use only one threshold value and identify the driving environment as an “urban area” when the near past vehicle stop time rate Rn is equal to or higher than the threshold value and the driving environment as a “suburban area” when the near past vehicle stop time rate Rn is lower than the threshold value.

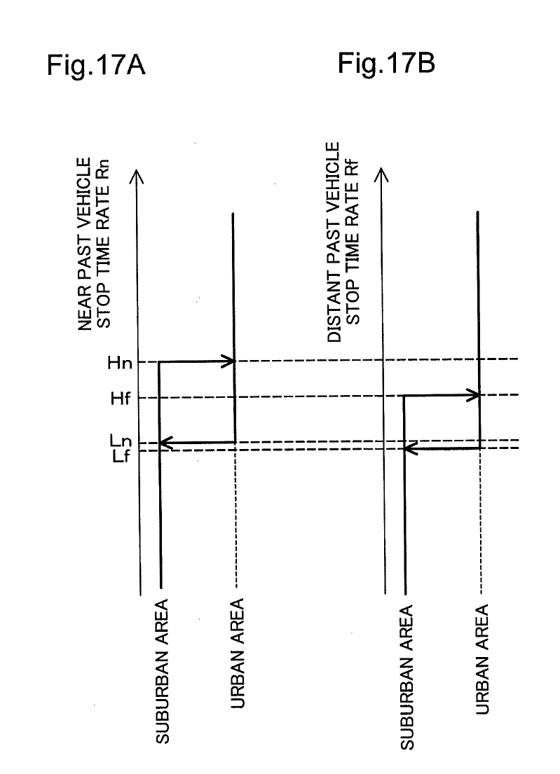

As shown in FIGS. 15 and 16, the algorithm of the embodiment sets the two threshold values (high threshold value Hn and low threshold value Ln) to provide hysteresis in identification either as the urban area or as the suburban area. As shown in FIG. 17A, the algorithm identifies the driving environment as an urban area when the near past vehicle stop time rate Rn increases from the value lower than the high threshold value Hn to be higher than the high threshold value Hn, identifies the driving environment as a suburban area when the near past vehicle stop time rate Rn decreases from the value higher than the low threshold value Ln to be lower than the low threshold value Ln, and otherwise keeps the previous value in the previous cycle of the processing. This configuration gives the accurate identification result as the “urban area” in the large-scale urban area as shown in FIG. 15A and the accurate identification result as the “suburban area” in the suburban area as shown in FIG. 15C. This, however, gives the identification results including both the “urban area” and the “suburban area” in the medium- or small-scale urban area as shown in FIG. 15B. Using only the near past vehicle stop time rate Rn may cause a problem that the medium- or small-scale urban area is not accurately estimated as the “urban area”. The algorithm of the embodiment accordingly uses the distant past vehicle stop time rate Rf having the longer measurement time than that of the near past vehicle stop time rate Rn, in addition to the near past vehicle stop time rate Rn.

In the medium- or small-scale urban area shown in FIG. 15B, setting a lower value to the low threshold value Ln excludes the “suburban area” from the identification result. In this case, however, when the driving environment changes from an urban area to a suburban area, such setting may result in a failure in identification as the “suburban area”. There is a limitation to set the lower value to the low threshold value Ln. It is accordingly difficult to accurately estimate a medium- or small-scale urban area as the “urban area” using only the near past vehicle stop time rate Rn.

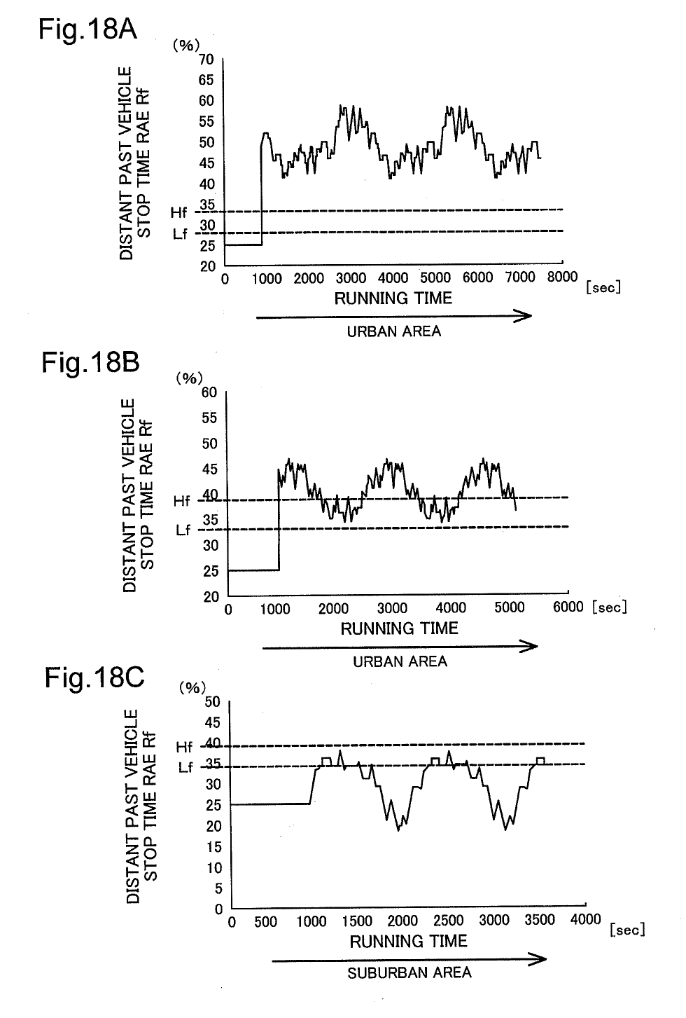

FIGS. 18A to 18C are graphs showing variations in distant past vehicle stop time rate Rf in the large-scale urban area, the medium- or small-scale urban area and the suburban area. These graphs show the variations in distant past vehicle stop time rate Rf obtained by actually driving a motor vehicle in the large-scale urban area, the medium- or small-scale urban area and the suburban area. The respective graphs have the running time as abscissa and the distant past vehicle stop time rate Rf as ordinate.

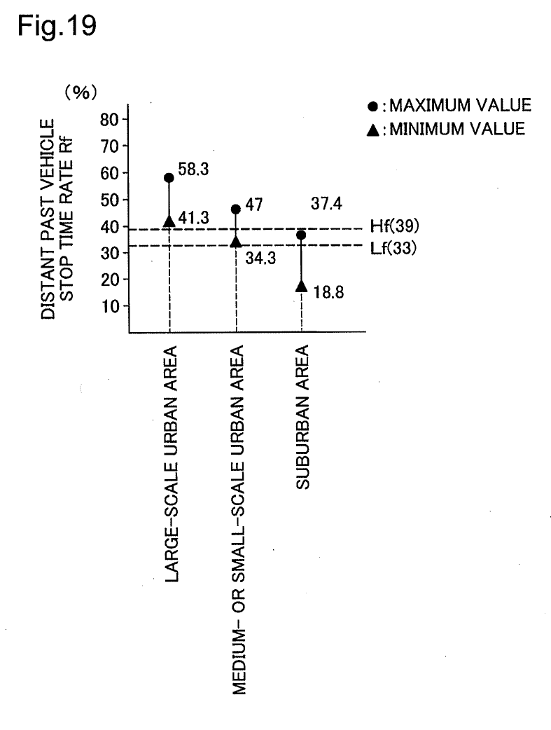

FIG. 19 is a graph showing maximum values and minimum values of the distant past vehicle stop time rate Rf in the large-scale urban area, the medium- or small-scale urban area and the suburban area. The closed circle represents the maximum value, and the closed triangle represents the minimum value in the graph. The respective maximum and minimum values are read from the graphs of FIGS. 18(a), 18(b) and 18(c).

As shown in FIG. 19, the distribution of the distant past vehicle stop time rate Rf in the large-scale urban area is 41.3 to 58.3%. The distribution of the distant past vehicle stop time rate Rf in the medium- or small-scale urban area is 34.3 to 47%. The distribution of the distant past vehicle stop time rate Rf in the suburban area is 18.8 to 37.4%. These results show that the respective distributions of the distant past vehicle stop time rate Rf in the large-scale urban area, the medium- or small-scale urban area and the suburban area cover the narrower ranges compared with those of the near past vehicle stop time rate Rn.

As shown in FIGS. 18A to 18C and FIG. 19, like the identification using the near past vehicle stop time rate Rn, the algorithm of the embodiment sets the two threshold values (high threshold value Hf and low threshold value Lf) to provide hysteresis in identification either as the urban area or as the suburban area. As shown in FIG. 17B, the algorithm identifies the driving environment as an urban area when the distant past vehicle stop time rate Rf increases from the value lower than the high threshold value Hf to be higher than the high threshold value Hf and identifies the driving environment as a suburban area when the distant past vehicle stop time rate Rf decreases from the value higher than the low threshold value Lf to be lower than the low threshold value Lf. This configuration gives the accurate identification result as the “urban area” in the large-scale urban area as shown in FIG. 18A and the accurate identification result as the “suburban area” in the suburban area as shown in FIG. 18C. Additionally, this configuration gives the accurate identification result as the “urban area” in the medium- or small-scale urban area as shown in FIG. 18B.

The above results show that the identification based on the distant past vehicle stop time rate Rf rather than the near past vehicle stop time rate Rn has the higher accuracy. The identification based on the distant past vehicle stop time rate Rf, however, requires the longer time period of 15 minutes and accordingly has the poorer response than the identification based on the near past vehicle stop time rate Rn. Accordingly the urban area/suburban area identification routine of this embodiment uses the identification result based on the near past vehicle stop time rate Rn in combination with the identification result based on the distant past vehicle stop time rate Rf for the final identification.

More specifically, the routine uses a logical sum (OR) of the identification result based on the near past vehicle stop time rate Rn and the identification result based on the distant past vehicle stop time rate Rf to detect a change to an urban area (step S910 in FIG. 14). This promptly gives the identification result as the urban area. The routine, on the other hand, uses a logical product (AND) of the identification result based on the near past vehicle stop time rate Rn and the identification result based on the distant past vehicle stop time rate Rf to detect a change to a suburban area (step S930 in FIG. 14). This gives the identification result as the suburban area with high accuracy.

### E. Advantageous Effects

The motor vehicle 200 of the above configuration identifies the driving environment as an urban area when the near past vehicle stop time rate Rn (or the distant past vehicle stop time rate Rf) increases from the value lower than the high threshold value Hn (or Hf) to be higher than the high threshold value Hn (or Hf), and identifies the driving environment as a suburban area when the near past vehicle stop time rate Rn (or the distant past vehicle stop time rate Rf) decreases from the value higher than the low threshold value Ln (or Lf) to be lower than the low threshold value Ln (or Lf). This prevents a change of the identification in the case of a temporary decrease of the vehicle stop time rate in the urban area or in the case of a temporary increase of the vehicle stop time rate in the suburban area. Accordingly this prevents temporary misidentification of the driving environment and improves the accuracy of identification.

The motor vehicle 200 obtains both the near past vehicle stop time rate Rn calculated in the shorter time period of 10 minutes and the distant past vehicle stop time rate Rf calculated in the longer time period of 15 minutes as the vehicle stop time rates and identifies whether the driving environment is an urban area or a suburban area based on these vehicle stop time rates Rn and Rf. Especially, the OR of the identification result based on the near past vehicle stop time rate Rn and the identification result based on the distant past vehicle stop time rate Rf is used to detect a change to an urban area. This provides the identification result as an urban area with good response. In this embodiment, the larger capacity for idle reduction is provided in the urban area. In terms of protection of the battery, the higher likelihood of identification as the urban area results in the lower risk. The good response in identification of the urban area is thus advantageous. The AND of the identification result based on the near past vehicle stop time rate Rn and the identification result based on the distant past vehicle stop time rate Rf is used to detect a change to a suburban area. This provides the identification result as a suburban area with high accuracy. Accordingly, the motor vehicle 200 identifies whether the driving environment is an urban area or a suburban area with both the good response and the high accuracy. This does not require any complicated configuration such as a car navigation system and simplifies the configuration of the apparatus.

According to this embodiment, immediately after the key starting operation, the urban area/suburban area distinction P1 is initially set to the value representing the suburban area. This may result in identification as a suburban area when the vehicle actually starts in an urban area. This is not a desirable state, since the battery 40 has a relatively low state of charge while a restart by idle reduction control has a relatively large electric load. In this embodiment, however, this does not cause any significant problem, because of the good response in identification of the urban area as described above.

This embodiment excludes the time period from the key starting operation to the time when the vehicle speed reaches the predefined speed V0, from the calculation of the vehicle stop time rates. The calculated vehicle stop time rates are thus effectively used in the system of idle reduction control. The idle reduction control does not allow the idle reduction state in the initial stage of a vehicle start, for example, because of catalyst warmup. Such exclusion from the calculation of the vehicle stop time rates accordingly ensures the adequate control.

As described above with reference to FIG. 6, the configuration of the embodiment does not cause the SOC to reach the lower limit value to restart the engine 10 in the stop and start period t2-t3. A restart of the engine due to the insufficient SOC in the middle of the stop and start period requires three to five times the amount of the fuel required when the SOC is increased with an increase in power during operation of the engine. In other words, the fuel consumption per unit SOC (for example, SOC of 1%) during operation of the engine is three to five times better than the fuel consumption when the engine is restarted due to the insufficient SOC in the middle of the stop and start period. Accordingly the motor vehicle 200 of the embodiment advantageously improves the fuel consumption over the conventional example.

Additionally, in the embodiment, the SOC distribution request level P3 (FIG. 4) is calculated based on the urban area/suburban area distinction P1 obtained with the good response and the high accuracy by the urban area/suburban area identification routine, and the capacity for idle reduction is determined based on the SOC distribution request level P3 (FIG. 5). This enables the capacity for idle reduction to be adequately determined in the usable SOC range W of the battery 40.

This embodiment adequately determines the capacity for idle reduction and thus effectively prevents the SOC from reaching the lower limit value to restart the engine 10 in the stop and start period t2-t3. Accordingly the motor vehicle 200 of the embodiment further improves the fuel consumption.

### F. Modifications

The invention is not limited to the embodiment or its modifications described above but may be implemented by a diversity of other aspects without departing from the scope of the invention. Some examples of possible modification are given below.

Modification 1

In the above embodiment, the SOC distribution request level is calculated based on both the urban area/suburban area distinction P1 and the own vehicle state P2. Alternatively the SOC distribution request level may be calculated based on only the urban area/suburban area distinction P1.

Modification 2

The above embodiment or any of its modifications identifies whether the driving environment of the vehicle is an urban area or a suburban area. The invention is, however, not limited to this configuration. Instead of the binary identification between the urban area and the suburban area, one modification may calculate an index that may take three or more values, as the degree of urbanization. The invention may be applied to this configuration by regarding the lowest value among the three or more values or a range from the lowest value to a predetermined value as the suburban area. In this case, two or more threshold values should be provided to be compared with the near past vehicle stop time rate Rn or the distant past vehicle stop time rate Rf.

Modification 3

In the above embodiment, the threshold values Hn, Hf, Ln and Lf are set to 47%, 39%, 34% and 33%. These values are, however, only illustrative and may be changed to any other suitable values. Additionally, the respective threshold values Hn to Lf are not necessarily required to have the relation of Hn>Hf>Ln>Lf but may have another magnitude relation such as Hn>Hf>Ln=Lf.

Modification 4

The above embodiment or any of its modifications identifies whether the driving environment is an urban area or a suburban area, based on both the near past vehicle stop time rate Rn and the distant past vehicle stop time rate Rf. The invention is, however, also applicable to a configuration of predicting the driving environment based on only one vehicle stop time rate, i.e., based on a rate of vehicle stop time in a predetermined time period. This modification may provide two threshold values for comparison, i.e., a high threshold value and a low threshold value and identify as an urban area when the vehicle stop time rate increases from the value lower than the high threshold value to be higher than the high threshold value and as a suburban area when the vehicle stop time rate decreases from the value higher than the low threshold value to be lower than the low threshold value.

Modification 5

In the above embodiment, the urban area/suburban area distinction P1 immediately after the key starting operation is initially set to the value 0 representing the suburban area. One modification may store the value of the urban area/suburban area distinction P1 at the time of the key-off operation in a non-volatile memory and set the urban area/suburban area distinction P1 immediately after the key starting operation to the value stored in the non-volatile memory. The distinction between the urban area and the suburban area is unlikely to be changed before and after parking. This accordingly ensures estimation of the driving environment immediately after a vehicle start with high accuracy.

Modification 6

In the above embodiment, the urban area/suburban area identification routine (FIG. 14) identifies as an urban area when at least one of the conditions that the near past vehicle stop time rate Rn is equal to or higher than Hn and that the distant past vehicle stop time rate Rf is equal to or higher than Hf is satisfied. The invention is, however, not limited to this configuration. One modification may identify as an urban area, based on determination that Rn is equal to or higher than Hn. In this modification, the distant past vehicle stop time rate Rf may be used for identification of whether the driving environment is a suburban area. For example, this modified configuration changes the processing of step S910 in FIG. 14 to determination of Rn≧Hn and changes the processing of step S930 to determination of Rf<Lf. Such modification has the simpler configuration and still ensures prediction of the driving environment with both the good response and the high accuracy.

Modification 7

The above embodiment identifies whether the driving environment is an urban area or a suburban area, based on the rates of vehicle stop time in predetermined time periods, i.e., the near past vehicle stop time rate Rn and the distant past vehicle stop time rate Rf. Alternatively the number of vehicle stops in a predetermined time period may be used for the identification. In general, any other parameter included in the vehicle stop degree data representing the degree of tendency of vehicle stop may be used, instead of the vehicle stop time rate or the number of vehicle stops.

Modification 8

In the above embodiment, the battery used is a lead acid battery. The invention is, however, not limited to this battery. The battery used may be another type of battery, for example, lithium ion battery or a rocking chair battery. The above embodiment describes the motor vehicle, but the invention is also applicable to a vehicle other than the motor vehicle, such as a train.

Modification 9

In the above embodiment, part of the functions implemented by the software configuration may be achieved by a hardware configuration (for example, integrated circuit), and part of the functions implemented by the hardware configuration may be achieved by a software configuration.

Modification 10

Among the components in the embodiment or each of the modifications described above, any of the components other than those described in independent claims are additional components and may be omitted appropriately. For example, one modification may omit the charge control that suppresses charging to the battery during ordinary running to save the fuel consumption and charges the battery by regenerative power generation during deceleration running.

### REFERENCE SIGNS LIST

10 engine
15 automatic transmission
20 differential gear
25 drive wheels
30 starter
34 drive mechanism
35 alternator
40 battery
50 ECU
70 auxiliary machinery
72 headlights
74 air conditioner
82 wheel speed sensor
84 brake pedal sensor
86 accelerator position sensor
88 battery current sensor
89 alternator current sensor
90 idle reduction controller
100 SOC controller
110 target SOC estimator
112 driving environment predictor
114 own vehicle state predictor
116 SOC distribution request level calculator
118 target SOC calculator
120 battery SOC calculator
130 feedback controller
200 motor vehicle
Rn near past vehicle stop time rate
Rf distant past vehicle stop time rate
Hn first high threshold value
Hf second high threshold value
Ln first low threshold value
Lf second low threshold value

1-6. (canceled)

7. A driving environment estimation apparatus, comprising:
a vehicle stop degree data acquirer configured to obtain vehicle stop degree data representing a degree of tendency of a vehicle stop state; and
an urban area/suburban area identifier configured to compare the obtained vehicle stop degree data with a threshold value and thereby identify whether a driving area of the vehicle is an urban area or a suburban area,
wherein the urban area/suburban area identifier provides a predetermined high threshold value and a low threshold value that is lower than the high threshold value, as said threshold value, and identifies as the urban area when the vehicle stop degree data increases from a lower value than the high threshold value to be higher than the high threshold value, and identifies as the suburban area when the vehicle stop degree data decreases from a higher value than the low threshold value to be lower than the low threshold value, wherein
the vehicle stop degree data acquirer obtains a first vehicle stop time rate that is a rate of vehicle stop time in a first time period and a second vehicle stop time that is a rate of vehicle stop time in a second time period longer than the first time period, as the vehicle stop degree data.

8. The driving environment estimation apparatus according to claim 7,
wherein the urban area/suburban area identifier provides a first high threshold value and a second high threshold value, as the high threshold value, and identifies as the urban area when the first vehicle stop time rate increases from a lower value than the first high threshold value to be higher than the first high threshold value or when the second vehicle stop time rate increases from a lower value than the second high threshold value to be higher than the second high threshold value.

9. The driving environment estimation apparatus according to claim 7,
wherein the urban area/suburban area identifier provides a first low threshold value and a second low threshold value, as the low threshold value, and identifies as the suburban area when the first vehicle stop time rate decreases from a higher value than the first low threshold value to be lower than the first low threshold value and when the second vehicle stop time rate decreases from a higher value than the second low threshold value to be lower than the second low threshold value.

10. A driving environment estimation method, comprising:
(i) obtaining vehicle stop degree data representing a degree of tendency of a vehicle stop state; and
(ii) comparing the obtained vehicle stop degree data with a threshold value and thereby identifying whether a driving area of the vehicle is an urban area or a suburban area,
wherein the step (ii) comprises:
providing a predetermined high threshold value and a low threshold value that is lower than the high threshold value, as the threshold value;
identifying as the urban area when the vehicle stop degree data increases from a lower value than the high threshold value to be higher than the high threshold value; and
identifying as the suburban area when the vehicle stop degree data decreases from a higher value than the low threshold value to be lower than the low threshold value, and
the step (i) comprises:
obtaining a first vehicle stop time rate that is a rate of vehicle stop time in a first time period and a second vehicle stop time that is a rate of vehicle stop time in a second time period longer than the first time period, as the vehicle stop degree data.
